(19) United States
(12) Patent Application Publication
(10) Pub. No.: US 2009/0205960 A1
(43) Pub. Date: Aug. 20, 2009

(54) DEVICE AND METHOD FOR DETECTING ARTICLES WITH PIPETTE AND NANOPORE

(75) Inventors: Tilman Schäffer, Erlangen (DE); Harald Fuchs, Nottuln (DE)

Correspondence Address: RATNERPRESTIA, P.O. BOX 980, VALLEY FORGE, PA, 19482, US

(73) Assignee: Westfalische Wilhelms-Universitat Munster, Munster (DE)

(21) Appl. No.: 12/375,099

(22) PCT Filed: Jul. 6, 2007
(86) PCT No.: PCT/EP2007/006012

§ 371 Date: Apr. 20, 2009

(30) Foreign Application Priority Data
Jul. 28, 2006 (DE) 10 2006 035 072.3

(51) Int. Cl. G01N 27/26; G01N 15/00

(52) U.S. Cl. 204/452; 204/601; 204/603; 204/451

(57) ABSTRACT

A device and a method for detecting and/or characterizing particles are shown. The device includes at least one nanopore, a voltage source for generating an electric potential difference between the two sides of the at least one nanopore in order to generate an ion current through the nanopore when the nanopore is surrounded by an electrolyte, and a measuring instrument adapted for recording a change in the impedance of the at least one nanopore in respect of the ion current when one or more particles that are to be detected and are present in the electrolyte pass(es) through the at least one nanopore. The device also includes a pipette with an end portion in which an opening is formed. A flow of the particles that are to be detected from outside the pipette is generated through the opening and through the nanopore, and the pipette is moved relative to a sample.

The invention relates to a device for detecting and/or analysing particles comprising the following: at least one nanopore, a voltage source for generating an electrical potential difference between the two sides of the at least one nanopore in order to produce an ion current through the nanopore when the nanopore is surrounded by an electrolyte, and a measuring device which is suitable for detecting a change in the impedance of the at least one nanopore in respect of the ion current if one or more of the particles to be detected and present in the electrolyte pass(es) through the at least one nanopore. The invention also relates to a method for detecting and/or analysing particles in accordance with the preamble of claim 21.

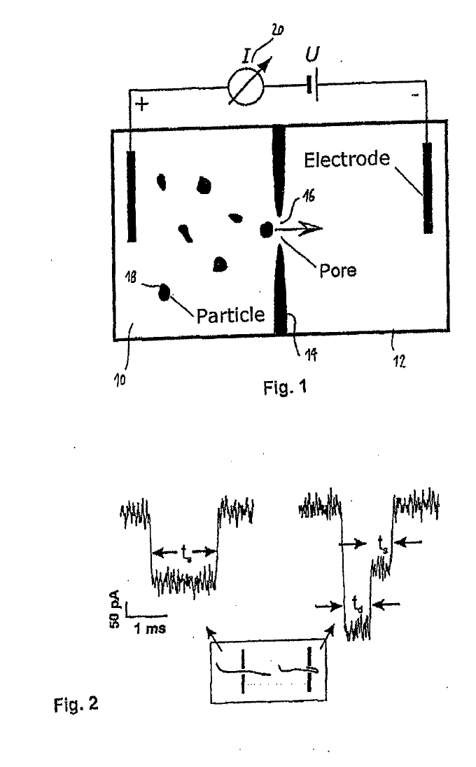

Nanopores are pores with diameters in the nanometre range. Nanopores are being increasingly used for the detection, analysis and sequencing of individual molecules, as described, for example, in Nakan J. J. et al. “Nanopore sensors for nucleic acid analysis” J. Phys.: Condens. Matter 15: R1365-R1393. With the aid of nanopores it is possible to obtain information about the composition and structure of the studied particles, which typically are molecules. A device of the type described above is shown schematically in FIG. 1. The device in FIG. 1 comprises two chambers 10, 12 separated by membrane 14. A nanopore 16 is formed in the membrane. There is an electrolyte in both chambers 10 and 12. In the left chamber 10 shown in FIG. 1 there are also particles 18. In this document the term “particle” denotes all small quantities of material that are in principle accessible to this described method of detecting and/or analysing, more particularly molecules, molecule complexes, macromolecule such as proteins and nucleic acids etc.

The nanopore 16 is the only passage for the electrolyte and the particles 18 between chambers 10 and 12. If a voltage is now applied between chambers 10, 12 an ion current flows through the pore 16 filled with the electrolyte. If the particles 18 are charged they are also driven through the nanopore 16 by electrophoresis. If the particles 18 are not charged they can be driven through the pore by way of a pressure gradient or electroosmotic flow.

In the device in FIG. 1 the ion current through the nanopore 16 is measured with a current measuring device 20. When one or more particles 18 pass(es) through the nanopore 16 it is temporarily blocked which results in a temporary reduction in the measured ion current. Through the frequency, duration and nature of the reduction conclusions can be drawn about the concentration and properties (e.g. the size and structure) of the particles. The current measuring device 20 is thus an example of a measuring device that is suitable for detecting a change in the impedance of the nanopore 16 in respect of the ion current if one or more of the particles 18 to be detected pass(es) through the nanopore 16.

FIG. 2 shows current signals obtained when particles (in this case DNA) pass through the nanopore 16. The measurements are taken from Chen P. et al (2004), “Probing Single DNA Molecule Transport Using Fabricated Nanopores”, Nano Lett. 4 (11): 2293-2298. The left current signal shows a reduction in current in the millisecond range when a DNA molecule passes “stretched” through the nanopore 16. The right signal shows a case in which the DNA molecule passes through the nanopore 16 in a partially folded state. As can be see in the right current signal, when the DNA molecule passes through the current falls to two different levels that are characteristic of the degree of blocking of the nanopore 16.

The device shown schematically in FIG. 1 is known by the name “Coulter” counter and is described, for example, in Bayley H. and C. R. Martin (2000), Chem. Rev. 100: 2575-2594.

The known Coulter counter in FIG. 1 is usually used for quantitative measurements of the sizes and concentrations of macromolecules in a reservoir that in FIG. 1 is formed by the left chamber 10. A further application which is currently being worked on consists in decoding DNA sequences with the aid of the Coulter counter. As the extent of the reduction in current is a measure of the physical size of the part of the DNA molecule located in the narrowest section of the pore 16, and as the nucleotides of the DNA molecule are of slightly different sizes, it should be possible to decode the genetic information of the nucleotides of a DNA molecule by time-resolution measurement of the ion current through the nanopore, i.e. the time-dependent variation in the impedance of the nanopore 16 as a DNA molecule passes through it. Current applications of the Coulter counter in FIG. 1 are therefore restricted to the analysis of particles contained in an unordered manner in a reservoir.

The aim of the present invention is to further develop the device and the method stated above in order to make it/them usable for applications other than the aforementioned analysis of particles.

This aim is achieved for a device of the type mentioned above in that that the device also comprises a pipette with an end section in which an opening is formed, in that it comprises means for generating a flow of the particles to be detected from outside the pipette through the opening and through the nanopore and in that it has means for moving the pipette relative to a sample.

The aim is also achieved by means of a method in accordance with claim 21.

In the device according to the invention the particles to be detected are taken up in the end section of the pipette through the opening As the pipette can be moved relative to a sample, with the aid of the devices in accordance with the invention particles can be detected and/or analysed in a spatially resolved manner as will be explained below with the aid of exemplary embodiments.

The pipette also allows to “catch” the detected and/or analysed particles. Particles that have been measured once can thereby be stored and, if necessary, measured again. This is a significant difference from the Coulter counter of FIG. 1, in which particles 18, which enter the right chamber 12 from the left chamber 10 via the nanopore 16, diffuse unhindered through the entire right chamber 12 and cannot be specifically subjected to further measurements.

The means for generating the particle current can at least partially be formed by the above-mentioned voltage source. This is especially advantageous if the particles to be detected are charged and are driven by electrophoresis into the pipette and through the nanopore in a way similar to the ions of the electrolyte. However, even with uncharged particles a particle current can be generated as an electro-osmotic flow as a result of the electrical potential difference between the two sides of the at least one nanopore.

If the particles to be recorded are not charged the device preferably comprises means for producing a difference in pressure between a section in the interior and a section in the exterior of the pipette.

In an advantageous embodiment the at least one nanopore is of variable size. The variable size of the nanopore allows the device to be used for detecting and/or analysing particles of different sizes. By changing the size of the nanopore it is also possible to distinguish the particles by size and even sort them. The size of the nanopore can also be adjusted depending on the properties of the particles to be detected such that there is an optimum signal-to-noise ratio.

In an advantageous embodiment the at least one nanopore of variable size is formed by a channel in a flexible material, the cross section of which can be narrowed through pressure on the flexible material. In another advantageous embodiment the at least one nanopore is arranged in a membrane and the cross-section of the nanopore can be changed by stretching the membrane.

Preferably the device includes a sample container for taking up the electrolyte and moving means for moving the pipette and the sample container relative to each other. The term “sample” in this document generally denotes any article or any object that can be investigated with the device and method according to the invention. For example, a sample can simply be constituted by an electrolyte in which the particles to be detected are contained or by a biological system, such as, for example, living cells surrounded by an electrolyte.

In an advantageous embodiment the moving means are designed to press the end section of the pipette into a compliant material lying opposite the opening in the end section in such a way that the effective opening area of the opening is reduced in order to thereby form a nanopore of variable size. Thus, in accordance with this embodiment the nanopore is formed by partially closing or covering the opening in the end section of the pipette if the end section of the pipette is pressed into the compliant material. In an advantageous embodiment the compliant material can be a surface of polymer material, more particularly poly(dimethylsiloxane). However, the compliant material can also be formed by the sample itself, for example a cell into which the end section of the pipette is pressed.

In a particularly advantageous embodiment the means of motion comprise an XYZ scanner. The device also preferably comprises a control device for controlling the XYZ scanner to scan the surface of a sample whereby the end section of the pipette is moved over the surface of the sample at a constant distance. In accordance with this advantageous embodiment the pipette acquires a function of a scanning probe microscope. In this way a sample can be scanned and at the same time the particles can be taken up through the opening of the pipette in a spatially resolved manner and detected and/or analysed with the aid of the nanopore.

Preferably the device comprises a dataprocessing system that is programmed in such a way that it records the relative movements carried out between the end section of the pipette and the sample during the scanning of surface of the sample and from this produces a topographic image of the sample and/or an image that represents the measurements of the particles as a function of the location of the pipette opening.

In an advantageous embodiment the distance between the end section of the pipette and the sample is adjusted based on an ion current through the opening in the end section of the pipette. In accordance with this further development the device also assumes the function of a scanning ion conductivity microscope as explained below with the aid of an exemplary embodiment. In another embodiment the distance between the end section of the pipette and the sample can be adjusted based on the shear forces acting on the end section of the pipette, as also described below with the aid of an exemplary embodiment.

Preferably the interior of the pipette has a first chamber which is directly connected to the opening in the end section of the pipette, and a second chamber, separated from the first chamber by a partition wall in which at least one nanopore is formed. Preferably the pipette also contains a third chamber separated from the first chamber by a partition wall in which also at least one nanopore is formed. Preferably the nanopore in the partition wall between the first chamber and the second chamber and the nanopore in the partition wall between the first chamber and the third chamber have a different opening area. This allows, for example, the particles to be detected to be sorted by size and/or measurements of particles of different sizes to be carried out simultaneously.

Additionally or alternatively the difference between the electrical potential of the second chamber and the first chamber has a sign opposite to that of the difference between the electrical potential of the third chamber and the first chamber. In this way the particles to be detected can also be distinguished and sorted by their charge.

Further advantages and features of the present invention are apparent from the following description in which the invention is explained with the aid of several exemplary embodiments with reference to the attached drawings in which

FIG. 1 schematically shows a prior art device for detecting and/or analysing particles;

FIG. 2 shows current signals that characterising a change in the impedance of a nanopore with respect to an ion current when a particle passes through the nanopore;

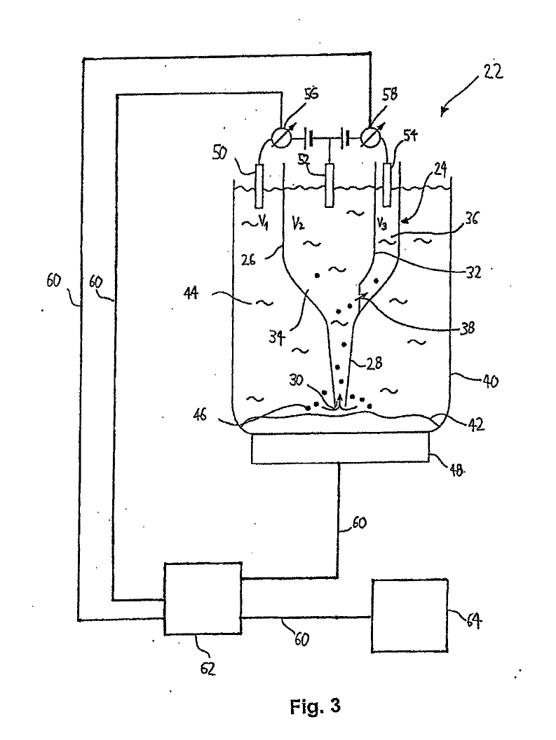

FIG. 3 is a schematic sectional view of a device in accordance with an embodiment of the invention;

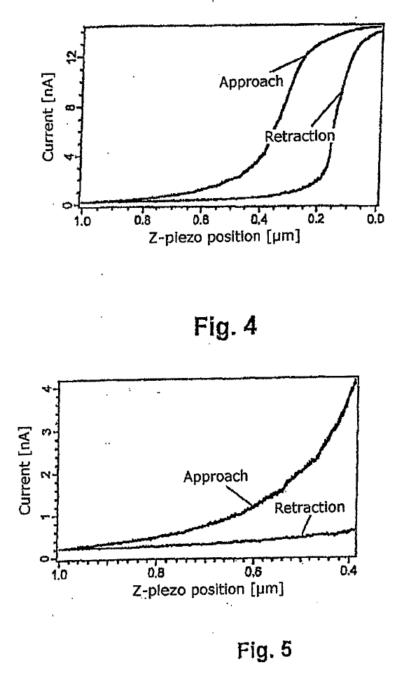

FIGS. 4 and 5 show the relationship between the ion flow and the distance between a pipette opening and a sample;

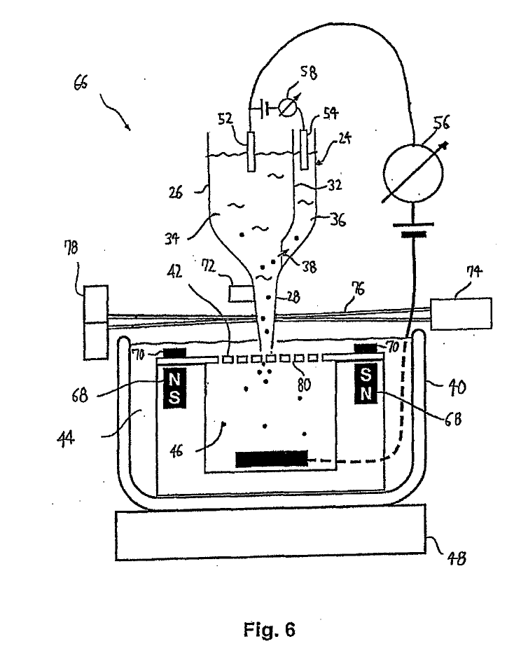

FIG. 6 shows a sectional view of a device in accordance with another embodiment of the invention;

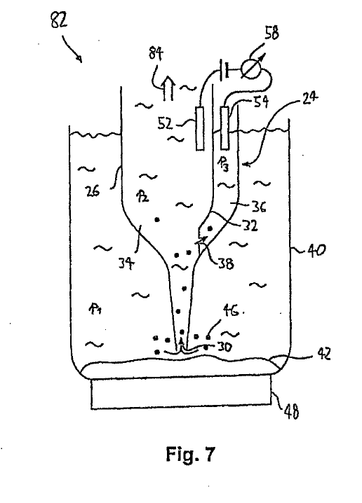

FIGS. 7 to 9 show different embodiments of pipettes for devices in accordance with further embodiments of the invention;

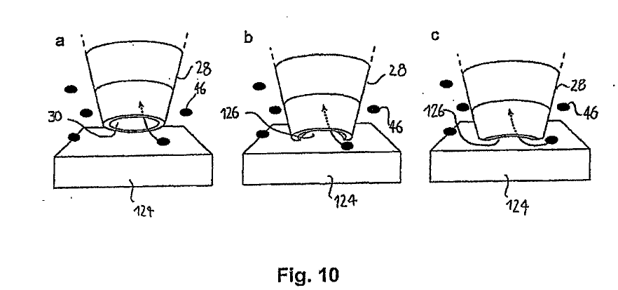

FIG. 10 schematically shows snap shots during the formation of a nanopore of changeable size by pressing the end section of a pipette into a compliant material; and

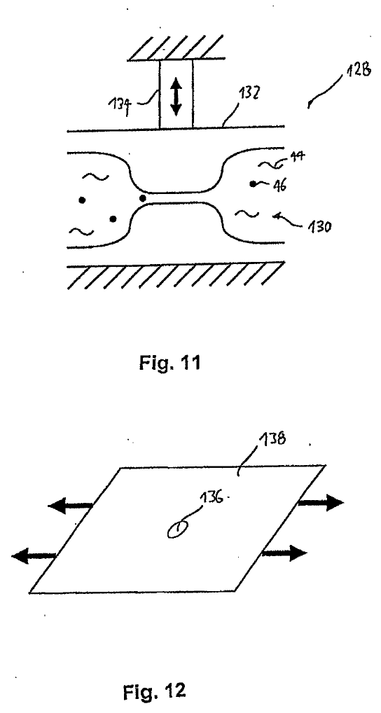

FIGS. 11 and 12 show examples of nanopores of different sizes.

In FIG. 3 a device 22 for detecting or characterising particles is schematically shown. The device 22 comprises a pipette 24 with a body section 26 and an end section 28 in which an opening 30 is formed. The pipette 24 is also known as a “nanopipette”. It is made, for example, of a glass tube with an internal diameter of typically 1 to 2 mm, one end of which is heated and drawn in order to form the end section 28. In the elongated end section 28 the internal diameter of the pipette 24 narrows over a range of typically a few millimetres to a minimal diameter at the opening 30 which can be between 40 nm and a few micrometres.

In the body section 26 of the pipette 24 there is a partition wall 32. The partition wall 32 separates a first chamber 34 of the interior of the pipette 24, which is connected to the opening 30, from a second chamber 36. A nanopore 38 is formed in the partition wall 32 which forms the only connection between the first and the second chambers 34, 36.

The nanopore 38 has a cross-section or opening area that is selected to be suitable for detecting and analysing particles in accordance with the Coulter principle which has been described in connection with FIG. 1. The diameter of the nanopore 38 depends on the specific application, and therefore on the size of the particles to be detected. In a typical application the diameter of the nanopore 38 is less than 30 nm (corresponding to an opening area of approx. 700 nm²) and preferably less than 15 nm (corresponding to an opening area of approx. 200 nm²). Note that in some embodiments of the pipette 24 the opening 30 is itself in the nanometre range and can therefore be regarded as a “nanopore”. However, in the illustrated example the opening 30 is considerably larger than the nanopore 38 and also does not fulfill the function of a nanopore according to the Coulter principle. If the end section 28 of the pipette 24 were to be so strongly drawn out that the opening were narrowed to a diameter of a few nanometres the resistance for the ion current through the end section 28, i.e. through the neck section of the pipette 24 would be too high to allow for Coulter measurements of good quality that can be achieved with the currently known measuring devices.

The pipette 24 is immersed in a container 40 on the base of which a sample 42 is located, which could, for example, be living cells. The container 40 is filled with an electrolyte 44, which in FIG. 3 is indicated by wave symbols. In the electrolyte 44 there are also particles 46 contained, for example molecules or molecule complexes, which are shown as dots in FIG. 3, one of which being designated with reference number 46 by way of example.

The container 40 is arranged on an XYZ scanner 48 with which it can be moved in all three dimensions relative to the pipette 24. Alternatively an XYZ scanner could also be provided with which the pipette 24 would be moved relative to the container 40 and the sample 42 contained therein.

A first electrode 50 is immersed outside the pipette 24 in the electrolyte 44 and keeps the electrolyte 44 in the container 40 at a first potential V₁. In the first chamber 34 of the pipette 24 there is a second electrode 52 which keeps the electrolyte in the first chamber 34 at a second potential V₂. Finally there is a third electrode 54 in the second chamber 36 which keeps the electrolyte in the second chamber 36 at a third potential V₃. A first current measuring device 56 essentially (i.e. except for the current flowing through the nanopore into the second chamber 36) measures the ion current of the electrolyte between the container 40 and the first chamber 34. A second current measuring device 58 measures the ion current of the electrolyte between the first chamber 34 and the second chamber 36. The currents measured by the current measuring devices 56 and 58 are transmitted via signal cables 60 to a computer 62. The computer 62 is connected via further signal cables 60 to the XYZ scanner 48 with which it can control the latter. The computer 62 is also connected via a further signal cable 60 to an output device, for example a monitor.

The operation of the device 22 of FIG. 3 will be described below. The computer 62 controls the XYZ scanner 48 in such a way that the end section 28 of the pipette 24 is moved at a constant distance over the surface of the sample. The distance between the end section of the pipette 24 and the sample 42 is set in accordance with a principle that is known per se from scanning ion conductivity microscopes. Due to the difference between the potentials V₁ and V₂ an ion current flows between the container 40 and the first chamber 34. This ion current is measured by a current measuring device 56. If the opening 30 approaches the sample 42, as of a certain distance a “choking effect” occurs which makes the passage of ions through the opening 30 difficult and thus leads to a reduction in the ion current measured by the device 56.

FIGS. 4 and 5 show the relationship between the distance between the end section 28 of the pipette 24 and the sample 42 on the one hand and the ion current measured through the opening 30 on the other hand. In the diagrams in FIGS. 4 and 5 the vertical movement (i.e. movement in the Z direction) of the container 40 by the XYZ scanner is represented by the X-axis and the current measured by the current measuring device 56 is represented by the Y-axis. FIG. 5 shows an enlarged part of the measurement in FIG. 4. In both diagrams the current-distance curve both for the approaching of the pipette 24 to the sample as well as the retraction thereof are shown. The difference between the two curves shows a hysteresis of the described “choking effect”.

In one embodiment the pipette 24 is moved over the sample 42 in such a way that the current measured by the current measuring device 56 is kept at a constant value. The measured current nearly corresponds to the ion current through the opening 30, reduced by the ion current through the nanopore 38, which, however, only constitutes a smaller fraction due to the small size of the nanopore 38. The computer 62 controls the XYZ scanner so that the ion current and therefore the distance between the pipette 24 and the sample 42 is kept constant during the scanning. The movements of the XYZ scanner performed during scanning of the surface of the sample 42 are recorded by the computer 62 and are used to produce a topographical image of the surface which is transmitted to the output device 64. Alternatively to the described procedure the pipette 24 could also at least in sections be moved at a constant horizontal level (i.e. at a constant Z-value of the XYZ scanner 48) across the sample 42, and the distance between the opening 30 and the sample 42 could be measured through changes in the measured current using the diagrams in FIGS. 4 and 5 in order to thereby also produce a topographic image or relief of the sample 42.

In the embodiment of FIG. 3 the particles 46 to be detected are charged and are moved due to differences between the potentials V₁, V₂, and V₃ from outside the pipette 24 through the opening 30 and through the nanopore 38 into the second chamber 36. When the particles 46 pass through the nanopore 38, the impedance of the nanopore 38 with regard to the ion current of the electrolyte varies, which results in current signals in the current measuring device 58 of the type shown in FIG. 2. By analysing the current signals of the current measuring device 58 particles 46 can be detected and analysed or characterised in a similar way to that described in connection with the Coulter counter of FIG. 1.

However, it becomes clear that the function of the device of FIG. 3 goes far beyond that of the conventional Coulter counter of FIG. 1. Since the particle flow of particles 46 goes through the opening 30 of the pipette 24, the particles can be detected and analysed in a spatially resolved manner depending on the current position of the pipette 24 with regard to the sample 42. For example, if the sample 42 is a living cell having a cell membrane in which channels are formed through which particles 46 pass, the emerging particle can be detected spatially resolved, e.g. the channels can be made “visible” through a locally increased concentration of particles. Also, particles passing through openings between cells of a cell layer can be detected and characterised. Similar examination can to date only be carried out by marking molecules. The device of FIG. 3, however, allows marking-free detection of molecules, particularly biomolecules. Also, by analysing the current signals at the current measuring device 58 the size, composition and/or structure of the particles can be analysed.

A further functional difference between the device in FIG. 3 and a conventional Coulter counter is that after passing through the nanopore 38 the particles do not diffuse through a large reservoir. Instead, after passing through the nanopore 38 the particles 46 are located in the spatially restricted second chamber 36 and can be removed therefrom for further analysis. Also, by reversing the polarity of the voltage between the electrodes 52 and 54 it is possible to drive a particle back and forth through the nanopore 38 at least twice whereby further information about the particle can be gained. In general the structure with the pipette 24 and, in particular, its chambers allow to enclose the particles to be studied or already studied in order to make them available for further analyses.

The signals measured by the current measuring device 58 are processed by computer 62. The computer 62 can generate an image that represents the measurements of the particles, for example their concentration, as a function of the location of the pipette opening 30.

FIG. 6 shows an alternative embodiment of a device 66 in accordance with a further embodiment of the invention. Identical or similar parts of the device 66 are provided with the same reference numbers as in FIG. 3. The device 66 comprises a pipette 24, the structure of which is identical to that of FIG. 3 and will therefore not be described again. The device 66 also comprises a container 40 holding an electrolyte 44 and particles 46 to be detected, a sample 42, which in the example of the embodiment of FIG. 6 is formed by a biological membrane, and an XYZ scanner 48. The membrane 42 is clamped between magnets 68 and an iron ring 70 and held in place thereby.

The main difference between the devices of FIGS. 3 and 6 consists in the distance measurement between the end section 28 of the pipette 24 and the sample 42. In the device 66 of FIG. 6 the distance is determined by the shear forces that occur when the end section of the pipette 24 approaches the sample 42. For this the end section 28 of the pipette 24 is made to oscillate using a piezo actuator 72. A laser 74 generates a laser beam 76 which is focused on the end section 28 of the pipette 24. The laser beam 76 hits a position-sensitive sensor, for example a segmented photodetector 78. When the end section 28 of the pipette 24 approaches the sample 42, shear forces occur which attenuate the vibration of the end section 28. The modulation of the vibration of the end section 28, which is characteristic of the shear forces, is detected by the photo detector 78.

The membrane (sample) 42 of FIG. 6 has openings 80 through which the particles 46 to be detected can pass. If the pipette 24 of the device 66 is scanned over the membrane 42 the openings 80 are on the one hand detected by modulation in the shear force, and openings are on the other hand by detected local changes in the concentration of the detected particles 46, and the particles can also be analysed in a spatially resolved manner.

FIG. 7 shows an alternative embodiment 82 of a device in accordance with a further embodiment of the invention. The device 82 comprises a pipette 24, the structure of which corresponds to those of FIGS. 3 and 6. The device in FIG. 7 comprises means (not shown) for producing a pressure difference between the pressure p₁ in the container 40 outside the pipette 24 and a pressure p₂ in the first chamber 34 of the pipette 24, wherein p₂<p₁. Due to this pressure difference a flow of particles from outside the pipette 24 through the opening 30 into the first chamber 34 of the pipette is generated, even in the case of uncharged particles 46 to be detected. The pressure p₃ in the second chamber 36 is yet lower than the pressure p₂ in the first chamber 34 so that at least part of the particle current passes through the nanopore 38.

The pressure difference can, for example, be produced by applying suction to chambers 34 and 36 as shown schematically by the arrow 84 in FIG. 7. Due to the pressure difference the level in the first chamber 34 as shown in FIG. 7 is higher than the level of the electrolyte in container 40. Although the pressure p₃ in the second chamber 36 is lower than p₂, in FIG. 7 the electrolyte level in the second chamber 36 is not visibly increased as the electrolyte and particle flow through the nanopore 38 is comparatively small due to the small cross section.

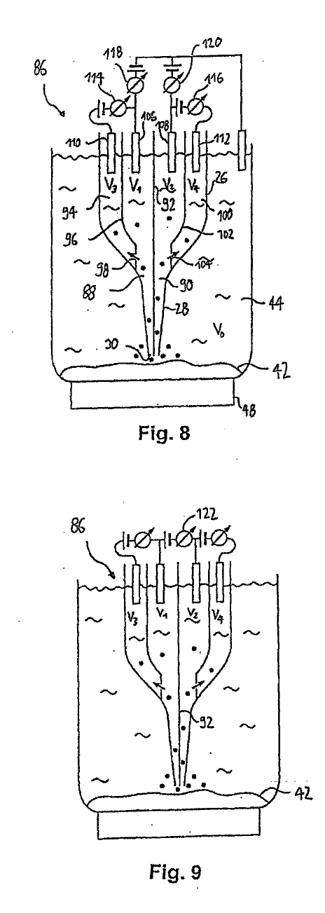

FIGS. 8 and 9 show alternative embodiments of the pipette. FIG. 8 shows a pipette 86 with a body section 26, an end section 28 and an opening 30. The pipette 86 comprises a first chamber 88 and a second chamber 90 which are separated from each other by a partition wall 92. The first and the second chamber 88, 90 are both connected to the opening 30. The pipette 86 also comprises a third chamber 94 which is separated from the first chamber 88 by a partition wall 96 in which a first nanopore 98 is formed. The pipette 86 also comprises a fourth chamber 100 which is separated from the second chamber 90 by a partition wall 102 in which a second nanopore 104 is formed. Arranged in the first chamber 88 is a first electrode 106 which keeps the first chamber at a potential V₁, in the second chamber 90 there is a second electrode 108 that keeps the second chamber 90 at a potential V₂, in the third chamber 94 a third electrode 110 that keeps the third chamber 94 at a potential V₃ and in the fourth chamber 100 a fourth electrode 112 that keeps the fourth chamber 100 at a potential V₄. With regard to the potentials V₁ to V₄ the following relationship applies: V₃>V₁>V₂>V₄. Outside the pipette 24 a bath electrode 114 is immersed in the electrolyte 44 which is at potential V₀, wherein V₁>V₀>V₂.

In the case of pipette 86 of FIG. 8 particles 46 of different charge can be detected and analysed separately. Negatively charged particles 46 are transported through the opening 30 into the first chamber 88 and some of them flow on through the first nanopore 98 into the third chamber 94. On passing through the first nanopore 98 changes in the impedance of the first nanopore 98 can be measured using a current measuring device 114 whereby particles 46 can be detected and characterised as described above. In a similar way positive particles 46 to be detected pass through the opening 30 into the second chamber 90 and on through the second nanopore 104 into the fourth chamber 100, whereby the positive particles can be detected and characterised as described above with the aid of a current measuring device 116. Using the current measuring devices 118 and/or 120 the distance between the end section 28 of the pipette 86 and the sample 42 can also be measured as described above so that the pipette 86 can be used as a scanning probe.

FIG. 9 shows the same pipette 86 as in FIG. 8, in which only the electrodes 106, 108, 110 and 112 are wired differently. For the sake of clarity all the reference numbers that are identical to those in FIG. 8 have been left out. The main difference between FIGS. 8 and 9 is that in the device in FIG. 9 the current flowing between the first chamber 88 and the second chamber 90 is measured. For this a current measuring device 122 is used which is connected between the first electrode 106 and the second electrode 108. The ion current between the first chamber 88 and the second chamber 90 flows around the lower end of partition wall 92 in the illustration of FIG. 9. This ion current is choked when the pipette 86 approaches the sample 42 so that it is suitable for measuring the distance.

FIGS. 8 and 9 only show examples of embodiments of the pipette that can be used for the device and method in accordance with the invention, and many further modifications are possible. For example, the first and second nanopores 98, 104 can be of different sizes in order to characterise and sort the particles 46 to be detected by size. The partition wall 92 in FIGS. 8 and 9 could be omitted and instead a number of chambers could be conceived which are each connected by a nanopore of different size to a main chamber, which in turn is connected to the opening 30.

A further form of embodiment of the present invention is described with reference to FIG. 10. FIG. 10 shows snap shots of the outermost end of an end section 28 of a pipette being pressed into a compliant material 124. The compliant material 124 can for example be a polymer material layer, for example a layer of poly-dimethylsiloxane specially provided for this purpose. However, the compliant material 124 can also be a sample, for example a cell. The means for moving the pipette relative to a sample, such as, for example, the XYZ scanner 48 of the previous figures, are designed to press the end section 28 of the pipette 24 into the compliant material 124 in such a way that the effective opening area of the opening 30 is reduced. This reduction in the opening area can be seen in the sequence of momentary images a to c in which the effective opening of the opening 30 is gradually narrowed in a sickle-shape. In this way the opening 30 becomes a nanopore of variable size.

In the example of FIG. 10 the pipette is orientated obliquely to the surface of the compliant material, which results in the sickle-shaped narrowing of the effective opening area. However, the pipette could also be orientated perpendicular to the surface and the end of the pipette made oblique.

As stated at the beginning, opening 30 of the pipette does not itself form the nanopore for detecting and characterising particles in accordance with the Coulter principle in the embodiments described in detail here. Rather, the opening 30 is larger than would be the case for Coulter measurements so that the resistance for the ion current through the end section of the pipette is not too great. Instead, in the embodiments of FIG. 3 and FIGS. 6 to 9 the nanopores are arranged in a partition wall in the interior of the pipette.

The embodiment of FIG. 10 shows a possibility of forming the nanopore during the operation of the device by narrowing the pipette opening 30 in the manner shown in FIG. 10, in order to thereby produce the suitable nanopore for the intended measurement. The device does not then require any further nanopores in the interior of the pipette.

When operating the device in accordance with this embodiment the pipette can, as described in connection with FIG. 3, be scanned over a sample, while the choking effect can be used for measuring the distance The pipette can then be moved further towards the sample for the purpose of particle measurement in order to thereby reduce the effective opening area of the opening 30. With the effective opening area reduced in this way the partially covered opening 30 can be used as a nanopore 126 for the Coulter measurement, wherein the effective opening area of the opening 30 can be varied in order to characterise the particles more precisely. The size of the effective opening area can, for example, be adjusted via the strength of an ion current in the presence of a known electrolyte flowing in between the passages of particles through the opening 30.

The nanopores 38, 98, 104 of FIGS. 3 and 6 to 9 may also have a variable cross-section. Examples of a nanopore with a variable cross-section are shown in FIGS. 11 and 12. FIG. 11 shows a nanopore 128 formed by a channel 130 in a flexible material 132. The channel 130 can for example be produced by way of conventional microcontact printing technology. A piezo actuator 134 is arranged in such a way that it can squeeze the flexible material 132 together and thereby narrow the channel 130 in order to thus reduce the cross-section of the nanopore 128. When the piezo actuator 134 contracts again, the channel 130 widens again. The adjustment of the size of the nanopore 128 is therefore reversible. In FIG. 11 the hatched areas indicate sections of a partition wall or membrane in which the nanopore 128 is arranged which could be, for example, sections of the partition wall 32 of FIG. 3.

FIG. 11 shows a nanopore 136 which is formed in a flexible membrane 138. By applying tension to the membrane as shown schematically by the arrows in FIG. 12 the membrane 138 becomes deformed and the size of the nanopore 136 changes. The tensile force can be applied, for example, by piezo actuators (not shown).

The features disclosed in the above description, the claims and the figure can be of relevance for implementing the invention in its various embodiments both individually and in any combination.

### LIST OF REFERENCE NUMBERS

10 First chamber
12 Second chamber
14 Partition wall
16 Nanopore
18 Particle
20 Current measuring device
22 Device according to an embodiment of the invention
24 Pipette
26 Body section
28 End section
30 Opening
32 Partition wall
34 First chamber
36 Second chamber
38 Nanopore
40 Container
42 Sample
44 Electrolyte
46 Particle to be detected
48 XYZ scanner
50-54 Electrodes
56 and 58 Current measuring devices
60 Signal cables
62 Computer
64 Output unit
66 Device according to an embodiment of the invention
68 Magnets
70 Iron ring
72 Piezo actuator
74 Laser
76 Laser beam
78 Photodetector
80 Membrane openings
82 Device according to an embodiment of the invention
84 Suction direction
86 Pipette
88 First chamber
90 Second chamber
92 Partition wall
94 Third chamber
96 Partition wall
98 Nanopore
100 Fourth chamber
102 Partition wall
104 Nanopore
106 to 112 Electrodes
114 to 120 Current measuring devices
122 Current measuring device
124 Compliant material
126 Nanopore of variable size
128 Nanopore of variable size
130 Channel
132 Flexible material
134 Piezo actuator
136 Nanopore of variable size
138 Membrane

1. A device for detecting and/or characterising particles comprising:
at least one nanopore,
a voltage source for generating an electrical potential between the two sides of the at least one nanopore in order to produce an ion current through the nanopore when the nanopore is surrounded by an electrolyte;
a measuring device that is suitable for detecting a change in the impedance of the at least one nanopore with respect to the ion current when one or more of the particles to be detected contained in the electrolyte pass(es) the at least one nanopore,
a pipette having an end section in which an opening is formed,
means for producing a particle flow of the particles to be detected from outside the pipette through the opening and through the nanopore; and
means for moving the pipette relative to a sample.

2. The device of claim 1 in which the means for producing the particle flow are at least partially formed by said voltage source.

3. The device of claim 1 in which the means for producing the particle flow comprises means for generating a pressure difference between a section in the interior and a section in the exterior of the pipette.

4. The device of claim 1 in which the at least one nanopore has an opening area of less than 2000 nm².

5. The device of claim 1 in which the at least one nanopore is of variable size.

6. The device of claim 5 in which the at least one nanopore is formed by a channel in a flexible material the cross section of which can be narrowed by applying pressure to the flexible material.

7. The device of claim 5 in which the at least one nanopore is arranged in a membrane and the cross-section of the nanopore is configured to be changed by stretching the membrane.

8. The device of claim 1, further comprising a sample container for containing the electrolyte and with moving means for moving the pipette and the sample container relative to each other.

9. The device of claims 5 and 8 in which the moving means are suitable for pressing the end section of the pipette into a compliant material facing the opening in the end section in such a way that the effective opening area of the opening is reduced in order to thereby form said nanopore of variable size.

10. The device of claim 9 in which the compliant material is formed of a polymer material, more particularly of poly-(dimethylsiloxane).

11. The device of claims 8 in which the moving means comprises an XYZ scanner.

12. The device of claim 11, further comprising a control system for controlling the XYZ scanner for scanning the surface of a sample moving the end section of the pipette at a constant distance across the surface of the sample.

13. The device of claim 12, further comprising a data processing system which is programmed in such a way that the relative movements between the end section of the pipette and the sample carried out during scanning of the surface of the sample are recorded and a topographical image of the sample is produced therefrom and/or an image is produced that represents the measurements of the particles as a function of the location of the pipette openings.

14. The device of claims 12 in which the distance between the end section of the pipette and the sample is adjusted based on an ion current through the opening in the end section of the pipette.

15. The device of claim 12 in which the distance between the end section of the pipette and the sample is adjusted based on shear forces that act on the end section of the pipette.

16. The device of claim 1 in which the interior of the pipette has a first chamber which is directly connected to the opening in the end section of the pipette, and a second chamber which is separated from the first chamber by a partition wall in which the at least one nanopore is formed.

17. The device of claim 16 in which the interior of the pipette comprises a third chamber which is separated from the first chamber by a partition wall in which at least one nanopore is formed.

18. The device of claim 17 in which the nanopore in the partition wall between the first chamber and the second chamber and the nanopore in the partition wall between the first chamber and the third chamber have different opening areas.

19. The device of claim 17 in which the difference between the electrical potentials of the second chamber and the first chamber has a sign opposite to that of the difference between the electrical potentials of the third chamber and the first chamber.

20. The device of claim 1 in which the particles are individual molecules or molecule complexes.

21. A method of detecting and/or characterising particles, comprising the steps of:
arranging at least one nanopore in an electrolyte containing particles to be detected;
generating an electrical potential difference between the two sides of the nanopore in order to produce an ion current through the nanopore; and
detecting changes in the impedance of the at least one nanopore with regard to the ion current when one or more of the particles to be detected pass(es) through the at least one nanopore;
wherein a particle flow of particles to be detected is generated from outside a pipette through an opening in an end section of the pipette and through the nanopore and in that the pipette is moved relative to a sample.

22. The method of claim 21 in which the size of the at least one nanopore is changed.

23. The method of claim 22 in which the end section of the pipette is pressed into a compliant material lying opposite the opening in the end section in such a way that the effective opening area of the opening is reduced in order to thereby produce a nanopore of variable size.

24. The method of claim 21 in which the end section of the pipette is moved at a constant distance across the surface of a sample and the relative movements between the end section of the pipette and the sample carried out during the scanning of the surface of the sample are recorded and used to produce a topographical image of the sample and/or an image representing the measurements of the particles as a function of the location of the pipette opening.

25. The method of claim 24 in which the distance between the end section of the pipette and the sample is adjusted based on an ion current through the opening in the end section of the pipette.

26. The method of claims 24 in which the distance between the end sections of the pipette and the sample is adjusted based on shear forces acting on the end section of the pipette.

27. The method of claim 21 in which the interior of the pipette comprises a first chamber which is directly connected to the opening in the end section of the pipette, and a second chamber which is separated from the first chamber by a partition wall in which the at least one nanopore is formed.

28. The method of claim 27 in which the interior of the pipette has a third chamber which is separated from the first chamber by a partition wall in which at least one nanopore is formed.

29. The method of claim 28 in which the nanopore in the partition wall between the first chamber and the second chamber and the nanopore in the partition wall between the first chamber and the third chamber have a different opening area.

30. The method of claims 28 in which a first potential is applied in the first chamber, a second potential is applied in the second chamber and a third potential is applied in the third chamber and the difference between the second potential and the first potential has a sign opposite to that of the difference between the third potential and the first potential.
